(19) United States
(12) Patent Application Publication
(10) Pub. No.: US 2001/0019013 A1
(43) Pub. Date: Sep. 6, 2001

(54) Electrical switch assembly for a motor vehicle with separate icon display

(76) Inventors: Adam Weber, Bietigheim-Bissingen (DE); Berthold Fein, Bietigheim-Bissingen (DE)

Correspondence Address: Andrew R. Basile, Young & Basile, P.C., 3001 West Big Beaver Road, Suite 624, Troy, MI, 48084, US

(21) Appl. No.: 09/798,139

(22) Filed: Mar. 2, 2001

(30) Foreign Application Priority Data
Mar. 4, 2000 (DE) 100 10 740

(51) Int. Cl. H01H 9/18

(52) U.S. Cl. 200/309; 200/308; 200/310

(57) ABSTRACT

A switch assembly for switching electrical currents in which a separate icon display is provided. The icon display can be attached to either the actuator of the switch assembly or the switch assembly so that different designs for one and the same switch assembly are possible without any modifications to the switch assembly.

### BACKGROUND

The invention concerns a switch assembly for switching electrical currents in a motor vehicle with a switch component, an actuator and an icon display located on the actuator.

Switch assemblies of this type are used in extremely large numbers, for example, in the instrument panel of motor vehicles.

Because of the low manufacturing costs, the manufacturers of these switch assemblies are interested in producing them in very large quantities in the same design. However, among the buyers of these switch assemblies, for example, the manufacturers of motor vehicles, there are trends in the opposite direction: in spite of large numbers, motor vehicles are being tailored more and more to the customers wishes.

In order to address this dilemma of large numbers of switch assemblies of the same style on the one hand and the desire of the buyers for individual designs for the switch assemblies, providing a switch with an interchangeable actuator is known. On page 308 of the March/August 1996 catalog from RS Components GmbH, Hessenring 13b, 64546 Mörfelden-Waldorf, a power switch is offered (order number 664-165) for which various pushbutton switches or lenses are offered. The disadvantage of this method of construction is that the actuator is connected detachably to the switch, and thus the switch becomes non-functional if the actuator is detached from the switch.

The object of the invention is to provide a switch assembly for switching electrical currents, which on the one hand can be produced in very large quantities and on the other hand allows an individual customer-specific design with simultaneous high operational safety for the switch.

### SUMMARY

The object is met by the invention by means of a switch assembly for switching electrical currents with a switch element, with an actuator and with a icon display located on the actuator, where the icon display is made as a separate component attached to the actuator, so that, without separating the switch assembly and the actuator from one another, the design of the switch assembly can be changed by replacing the icon display. Consequently, it is possible on the one hand to manufacture switches and actuators in the maximum quantity and to assemble switches and actuators during the production process into a functional unit. On the other hand, it is possible, by changing the icon display, to adapt the appearance of the switch according to the invention individually to the customer's wishes and to achieve greater acceptance with the customer. By changing the icon display, the technically identical switch can be sold to different customers with a different design.

The object is also achieved by means of a switch assembly for switching electrical currents in a motor vehicle, with a switch element, an actuator and an icon display which is designed as a separate component attached to the switch assembly, so that the design and the function of the switch assembly is determined by applying the icon display to the switch assembly. Modifications to the design can be made simply and economically without affecting the manufacture of the switch assembly.

To supplement the invention, provision is made for attaching the icon display to the actuator or to the switch assembly by a snap connector, so that the attachment of the icon display and the actuator can be realized or released without special tools and in a very simple fashion.

A variation of the invention provides for making the symbol releasably attached to the actuator or the switch assembly, so that the appearance of the switch assembly can be changed during the service life of the switch by replacing the icon display. This makes it possible, for example, to achieve a like-new visual impression and/or a more modern appearance in second-hand vehicles by replacing the icon display.

In another embodiment of the invention, provision is made for the icon display to have one or more locking means and for the one or more locking means to activate or deactivate one or more functions of the switch. The locking means can lock out the switching motion of the switch assembly, so that unintentional actuation of the switch assembly is prevented. Alternatively, the locking means can be designed in such a way that when the icon display is applied, the ultimate function of the switch is established to match the icon. In this way, a switch assembly having several functions can be produced in even larger quantities, and the function of the switch is not determined until the symbol display is applied.

As a supplement to the invention it is intended that the switch is a rocker switch and/or that the switch element is designed to be touch operated, so that the switch according to the invention can be used for different purposes.

In a further embodiment of the invention, the icon display and/or the actuator can be illuminated, so that the switch according to the invention can be identified and operated easily even in the dark.

In another embodiment of the invention, the icon display extends at least over almost the entire length of the actuator panel so that adequate space is available for depicting one or more icons which indicate the function of the switch assembly. In addition, as the result of the elongated design of the icon display, the switch assembly according to the invention has an elegant and streamlined appearance.

Additional advantages and advantageous embodiments of the invention can be seen in the drawing and its description as well as the appended patent claims.

### BRIEF DESCRIPTION OF THE DRAWING

FIG. 1 is a perspective view of a switch according to the invention;

FIG. 2 is a perspective view of several switches according to the invention, some with the icon display removed;

FIG. 3 is a perspective view of another embodiment of several switch assemblies according to the invention; and

FIG. 4 is a perspective view of a switch according to the invention with locking means.

### DETAILED DESCRIPTION

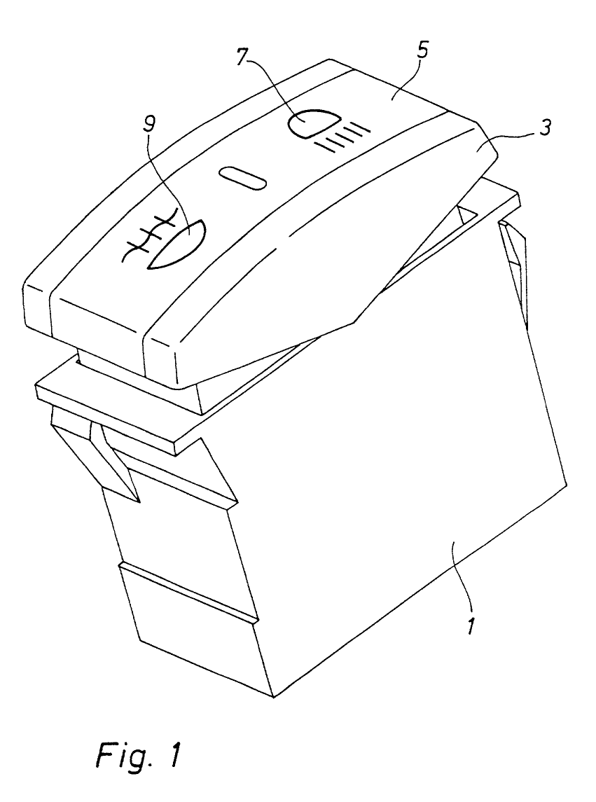

FIG. 1 shows a first embodiment of a switch assembly 1 according to the invention implemented as a switch. The switch assembly 1 has an actuator 3, which can be moved to different switch positions. An icon display 5 is applied on the top side of the actuator 3 extending over the entire length of the actuator panel 3. The icon display 5 contains a symbol 7 for function “a” of a motor vehicle, for example, and a symbol 9 for function “b” of a motor vehicle, for example. In the center switch position of the switch assembly 1 shown in FIG. 1, the functions “a” and/or “b” can be switched off depending on the implementation of the switch assembly. If the operator of the motor vehicle presses the actuator 3 in the area of the symbol 7, function “a” headlamps, for example, is switched on; if he presses the actuator 3 in the area of the symbol 9, function “b” is switched on. Icons of this kind were applied previously by means of pad printing, embossed sheet, lasers or similar means directly onto the actuator 3. With this method there is the accompanying necessity of determining the function of the switch assembly according to the invention at the time of production. In addition, the exterior form of the switch assembly apparent to the operator of the motor vehicle is determined once and for all when the icon is imprinted.

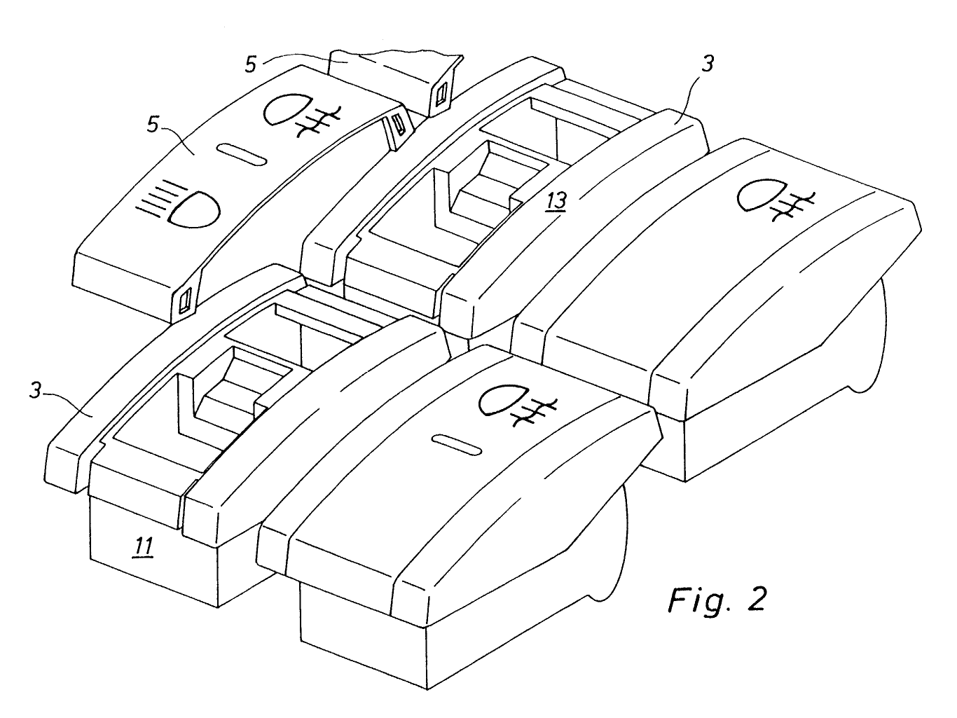

FIG. 2 shows perspective drawings of several switch elements according to the invention. The switch assemblies 11 and 13 have no icon displays on the actuators 3. In an exploded view, the icon displays 5 are shown above the corresponding switches 11 and 13. From this drawing it is clear that the function of the switches 11 and 13 according to the invention is determined only when the icon displays 5 are applied. In this respect, the switch element according to the invention can be produced continuously in very large quantities, and the function of the switch assembly is not determined until an order is received, when the corresponding icon display 5 is applied to the switch assembly 11 or 13. The connection of icon display 5 and actuator 3 can be achieved by a releasable or non-releasable attachment.

Naturally, it is also conceivable that the buyer of the switch component according to the invention designs the icon field 5 himself and also produces it himself. There is a standardization of switch assemblies in a motor vehicle in as much as the same switch component can be used for different functions, and it only has to adapted by using another icon display.

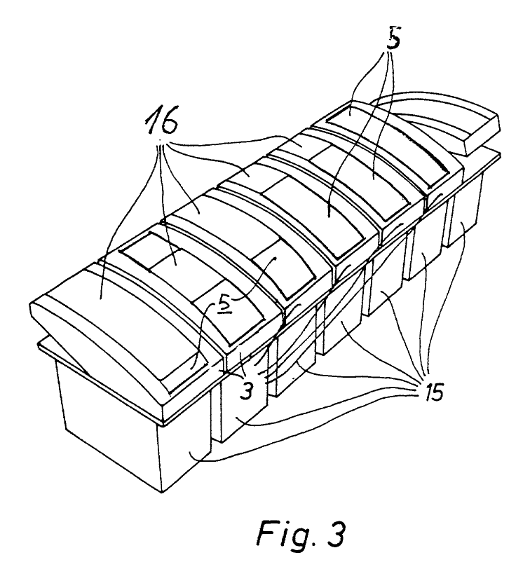

FIG. 3 is a perspective drawing of a row of possible switch assemblies 15 according to the invention positioned next to one another. In the case of these switch assemblies, the icon displays 5 have printable areas 16 of different sizes. This further increases the design latitude of the switch assemblies 1 according to the invention.

In a first design shape in accordance with FIG. 3, the printable area 16 extends over almost the entire length of the icon display 5. In one of the next switch assemblies 15, the printable area 16 is positioned in the middle of the icon display 5. On both sides of the printable area 16, textured gripping surfaces can be located on the icon display 5 or the actuator 3, which make operation easier. The other switch assemblies 15 shown in FIG. 3 show different versions of the icon displays 5 and printable areas 16. One of the icon displays extends from one end of the display to beyond the center, while in the case of the other switch assemblies, the printable areas 16 are located at the end of the icon display.

The invention is not restricted to rocker switches, but can also be used for pushbuttons, locking switches and pushbutton switches. The icon displays 5 can also be designed in such a way that they can be installed rotated by 180°.

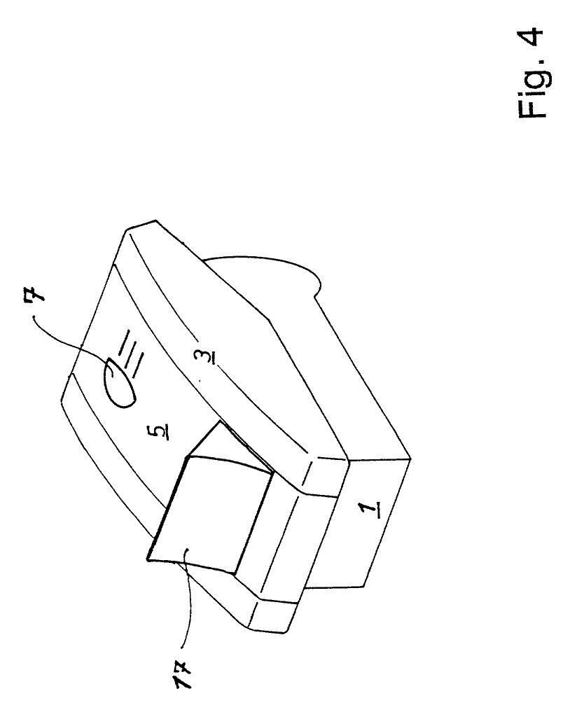

FIG. 4 shows an additional embodiment of a switch assembly 1 according to the invention. An icon bar 5 with a symbol 7 and a locking element 17 are located on the actuator 3. The locking element 17 is can be moved in the direction of the longitudinal axis of the actuator 3 between two positions, not shown in FIG. 4. In a first position of the locking element 17, the actuator 3 can be moved back and forth between its switch positions, which are also not shown. In a second position of the locking element 17, it locks the actuator 3, so that the latter remains in its switched position. This effectively inhibits any unintentional operation of the actuator 3.

All features presented in the description, the drawing and the patent claims can be essential to the invention both individually and in any combination with one another.

What is claimed is:

1. Switch assembly for switching electrical currents for a motor vehicle, with a switch element (1), with an actuator (3) and with an icon display (5) located on the actuator (3), characterized in that the icon display (5) is implemented as a separate component attached to the actuator panel (3).

2. Switch assembly for switching electrical currents for a motor vehicle, with a switch (1), with an actuator (3) and with an icon display (5) located on the actuator (3), characterized in that the icon display (5) is implemented as a separate component attached to the switch assembly (1)

3. Device in accordance with claim 1 or 2, characterized in that the icon display (5) is attached by means of a snap connector to the actuator (3) or the switch assembly (1).

4. Device in accordance with claim 1 or 2, characterized in that the icon display (5) is attached separably to the actuator (3) or the switch assembly (1).

5. Device in accordance with one of the preceding claims, characterized in that the icon display (5) has one or more means for locking, and that the one or more means for locking activate or deactivate one or more functions of the switch assembly.

6. Device in accordance with one of the preceding claims, characterized in that the switch assembly (1) is a rocker switch.

7. Device in accordance with one of the preceding claims, characterized in that the switch assembly (1) is designed to be touch operated.

8. Device in accordance with one of the preceding claims, characterized in that the icon display (5) and/or the actuator (3) can be illuminated.

9. Device in accordance with one of the preceding claims, characterized in that the icon display (5) extends at least over almost the entire length of the actuator (3).
